(19) United States
(12) Patent Application Publication
(10) Pub. No.: US 2005/0216918 A1
(43) Pub. Date: Sep. 29, 2005

(54) Window management system

(75) Inventor: Hideaki Kuraishi, Kawasaki (JP)

Correspondence Address: STAAS & HALSEY LLP, SUITE 700, 1201 NEW YORK AVENUE, N.W., WASHINGTON, DC, 20005, US

(73) Assignee: Fujitsu Limited, Kawasaki (JP)

(21) Appl. No.: 11/012,239

(22) Filed: Dec. 16, 2004

(30) Foreign Application Priority Data
Mar. 25, 2004 (JP) 2004-089916

(51) Int. Cl. G06F 13/00

(52) U.S. Cl. 719/316; 719/328

(57) ABSTRACT

A control unit 102 registers window group information associated with each window group on a window group management DB 121, and registers window information associated with each window on a window management DB 119. Then, the control unit 102 executes a process related to the display of the window by a window-group basis on the window group information registered on the window group management DB 121 and the window information registered on the window management DB 119.

### BACKGROUND OF THE INVENTION

1. Field of the Present Invention

The present invention relates to a window management system for managing a window displayed on a screen when executing an application program on a personal computer and so forth.

2. Description of the Related Art

On the personal computer, etc., a plurality of application programs can be executed in parallel owing to highly-sophisticated functions of an operating system, and, along with this, a plurality of windows are displayed on a screen of a monitor, etc. corresponding to executing of the individual application programs. Then, a variety of methods for managing the plurality of windows are proposed (for example, Japanese Patent Application Laid-Open Publication No.2001-325054).

In the conventional window management methods given above, however, the windows are simply displayed in enumeration. Therefore, for instance, if a user of the personal computer, etc. finishes one of a plurality of operations conducted in parallel, the user is unable to immediately recognize which window should be closed, and there is necessity of closing the window corresponding to the operation to be terminated after confirming a display content in each window, which operation is troublesome.

### SUMMARY OF THE INVENTION

The present invention was devised to solve the problems of the prior art, and aims at providing a window management system enabling quick recognition about a window in a user's operation.

A window management system of the present invention manages a window displayed on a screen when executing an application program, and comprises a first registration unit registering information of a plurality of window groups corresponding to operation of a user, a second registration unit registering information of the window as being related to any one of the plurality of window groups, and a display control unit executing a predetermined process related to the display of the window by a window-group basis on the basis of the information of a plurality of window groups registered by the first registration unit and the information of the window registered by the second registration unit.

With this construction, each window is registered in any one of the window groups associated with the operations of the user, and further the predetermined process related to the display is executed by the window-group basis. Accordingly, the user is able to quickly recognize which operation each window corresponds to.

Further, a window management system according to the present invention further comprises a first setting unit setting the priority of the window, wherein the display control unit performs control of displaying the window on the basis of the priority level of the window.

With this construction, the proper window display control based on the priority level can be attained.

Moreover, the window management system according to the present invention further comprises a second setting unit setting a window hierarchy with respect to a first window displayed on the screen when executing a predetermined application program and a second window displayed on the screen when executing an application program to be executed in subordination to the predetermined application program, wherein the display control unit performs control of displaying the window on the basis of the window hierarchy.

This construction enables the proper window display control based on the hierarchy by clarifying a subordinate relationship between the window displayed on the screen when executing the predetermined application program and the window displayed on the screen when executing the application program to be executed in subordination to the predetermined application.

Furthermore, in the window management system according to the present invention, the display control unit performs any one of control of displaying the operation window containing the windows of which information is registered as being related to one window group by the second registration unit, control of displaying any one of the windows contained in the operation window on a forefront screen, control of batch-terminating the display of the windows contained in the operation window, control of minimizing the display of the operation window, control of maximizing the minimized display of the operation window, and control of changing a position of the window within the operation window.

This construction enables usability of the user to be improved because of executing the predetermined process related to the display of the window by the window-group basis.

Moreover, the window management system according to the present invention further comprises delete means for deleting the information of the window.

With this construction, an unnecessary window can be excluded from management target windows.

Further, the present invention may be a method by which a computer or other device, machine, etc. executes any one of the processes. Still further, the present invention may be a program for making the computer, other device, or machine, etc. actualize any one of the functions. Yet further, the present invention may be a storage medium readable by the computer, etc., which is stored with this type of program.

The present invention enables the user to quickly recognize which operation each window corresponds to by registering each window in any one of the window groups corresponding to the operations by the user and further executing the predetermined process related to the display of the window by the window-group basis.

### BRIEF DESCRIPTION OF THE DRAWINGS

FIG. 1 is a diagram showing a processing example of a window management system according to an embodiment of the present invention;

FIG. 2 is a diagram showing an example of a desktop screen managed by the window management system;

FIG. 3 is a block diagram of a user terminal;

FIG. 4 is a flowchart of an operation when starting up a related window management program;

FIG. 5 is a flowchart of an operation when terminating the related window management program;

FIG. 6 is a flowchart of an operation when registering window group information;

FIG. 7 is a diagram showing one example of the window group information;

FIG. 8 is a flowchart of an operation when deleting the window group information;

FIG. 9 is a flowchart of an operation when registering window information;

FIG. 10 is a diagram showing a first example of a display screen;

FIG. 11 is a diagram showing a second example of the display screen;

FIG. 12 is a diagram showing one example of the window information;

FIG. 13 is a flowchart of an operation when deleting the window information;

FIG. 14 is a flowchart of other operation when registering the window information;

FIG. 15 is a flowchart of other operation when deleting the window information;

FIG. 16 is a flowchart of an operation when independently displaying the window;

FIG. 17 is a flowchart of an operation (1) when operating the window;

FIG. 18 is a flowchart of an operation (2) when operating the window;

FIG. 19 is a diagram showing another example of the window information;

FIG. 20 is a diagram showing a third example of the display screen; and

FIG. 21 is a diagram showing a fourth example of the display screen.

### DESCRIPTION OF THE PREFERRED EMBODIMENTS

A window management system in a best mode (which will hereinafter be termed an embodiment) for carrying out the present invention will hereinafter be described with reference to the drawings.

<<Outline of Functions>>

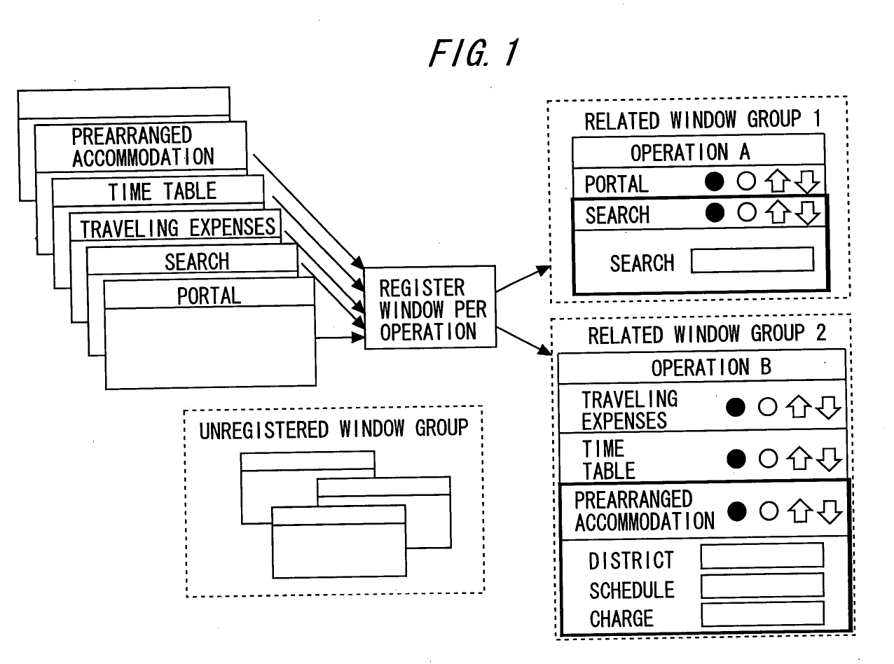

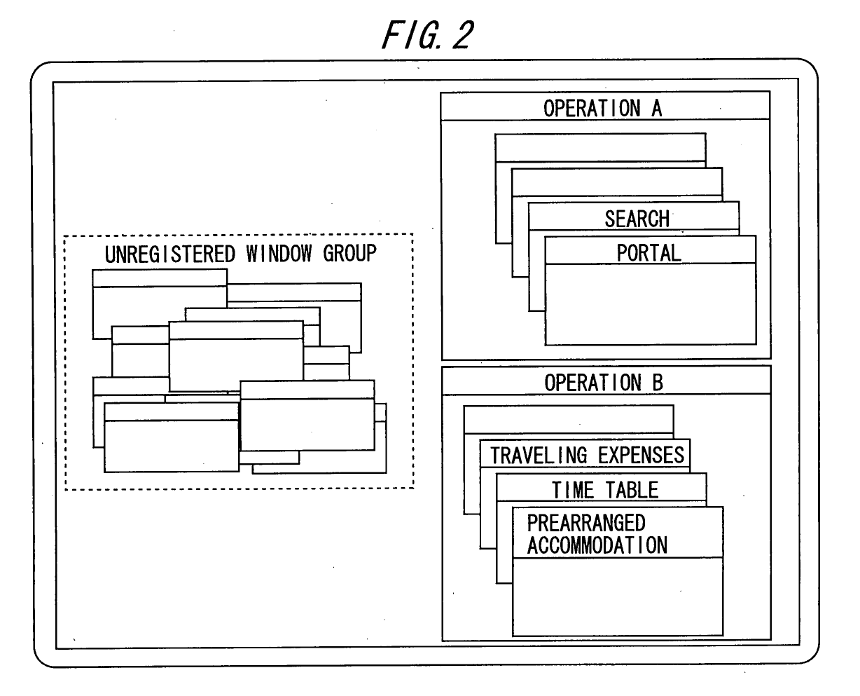

FIG. 1 is a diagram showing an example of processing of the window management system. FIG. 2 shows an example of a desktop screen of a computer that is managed by this window management system. This window management system supports a user's operation on the window displayed on the desktop screen (which will hereinafter be simply called a screen) on the computer utilized by a user. To be specific, this window management system provides a function of making a visual arrangement by sorting out the windows on the screen into groups and organizing a window configuration on the screen. Herein, the windows are defined as components on the screen that serve as user interfaces for various categories of computer programs executed on the user's own computer.

The example in FIG. 1 shows a variety of windows given names such as [portal], [search], [traveling expenses] [timetable] and [prearranged accommodation]. Normally, these windows are laid out at random on the screen. Therefore, when the user simultaneously opens a multiplicity of windows, the user gets troublesome to handle the windows.

The window management system, upon responding to the user's operation, classifies the above variety of windows according to classifications called operations, and registers the windows on a database. The operations are represented such as an operation A, an operation B in FIG. 1, and are also called groups in the embodiment. Then, the window management system displays the individual windows in alignment which are registered in operation windows provided corresponding to the classifications such as the operation A, the operation B and so on.

For instance, in the example in FIG. 1, the windows named [search] and [portal] are displayed in the operation window of the operation A. Further, the window named [search] is displayed on the forefront screen in the operation A. Moreover, a variety of operation buttons are provided adjacent to the names of the windows displayed in the operation window. For example, in FIG. 1, the operation buttons represented by symbols such as a black circle, a white circle, an upward arrowhead, a downward arrowhead, etc. are displayed beside the window names such as [search], [portal] and so on.

Similarly, the windows named [prearranged accommodation], [time table] and [traveling expenses] are displayed in the operation window of the operation B. In the operation window of the operation B, the window named [prearranged accommodation] is displayed on the forefront screen. As a result, a window group classified by the operation A constitutes a related window group 1. Further, a window group classified by the operation B constitutes a related window group 2.

On the other hand, on this computer, windows that are not registered in the window management system are displayed in a random positional relationship as a unregistered window group. Thus, the window management system provides the function of classifying the individual window on which the user performs the operation and registering the window. As a result, the thus-classified windows are sorted out according to the classifications and displayed on the screens. While on the other hand, the windows ruled out of objects of the classifications become the unregistered windows.

FIG. 2 shows an example of the desktop screen managed by the window management system. As shown in FIG. 2, there are displayed the windows (the windows having the names such as [search], [portal], etc.) grouped into the operation windows of the operation A, the operation B and so forth. On the other hand, the ungrouped windows are displayed as the unregistered window group.

<<System Constitution and Example of Processes>>

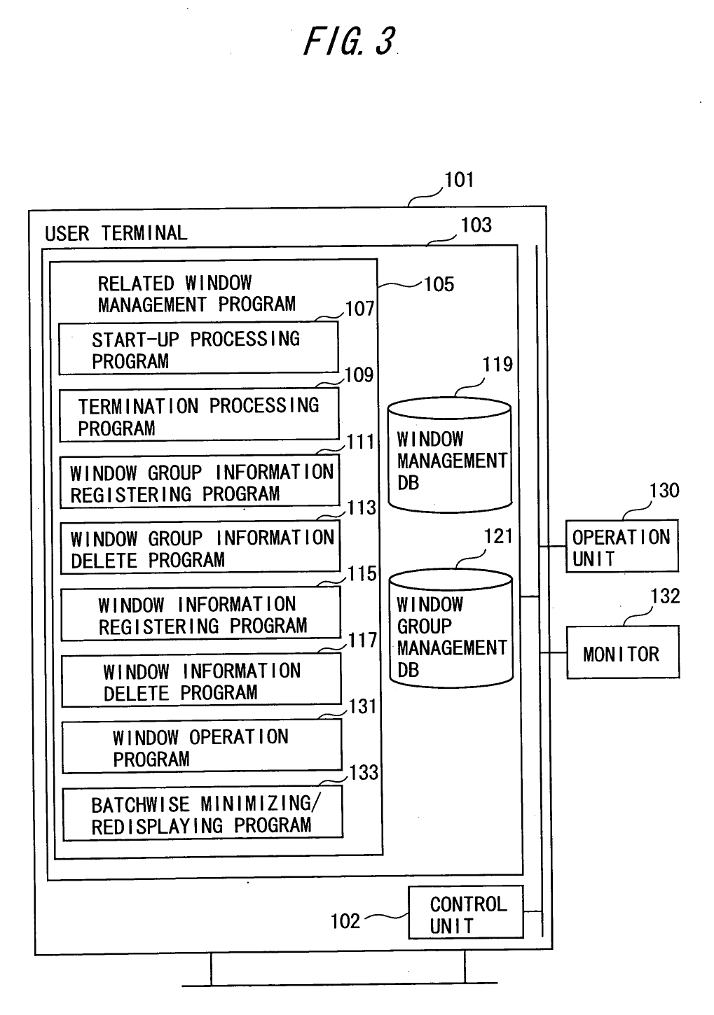

FIG. 3 shows a block diagram of a user terminal as the window management system in the embodiment of the present invention. In FIG. 3, a user terminal 101 conducts the management of the windows, specifically, registers the window displayed on the screen when executing the application program as any one of the window groups corresponding to the operations of the user, and further executes a predetermined process related to the displaying of the window by a window-group basis.

This user terminal 101 is, for instance, a personal computer and is constructed of a control unit 102 such as a CPU, etc., a memory 103 for storing programs and databases, an operation unit 130 such as a keyboard, a mouse, etc. operated by the user, and a monitor 132.

Among these units, the memory 103 is stored with a related window management program 105, and a window management database (DB) 119 and a window group management DB 121 are built up therein. Further, the related window management program 105 is structured of a start-up processing program 107, a termination processing program 109, a window group information registering program 111, a window group information delete program 113, a window information registering program 115, a window information delete program 117, a window operation program 131 and a batch minimizing/redisplay forefront display program 133.

Operations of the thus-constructed user terminal will be explained.

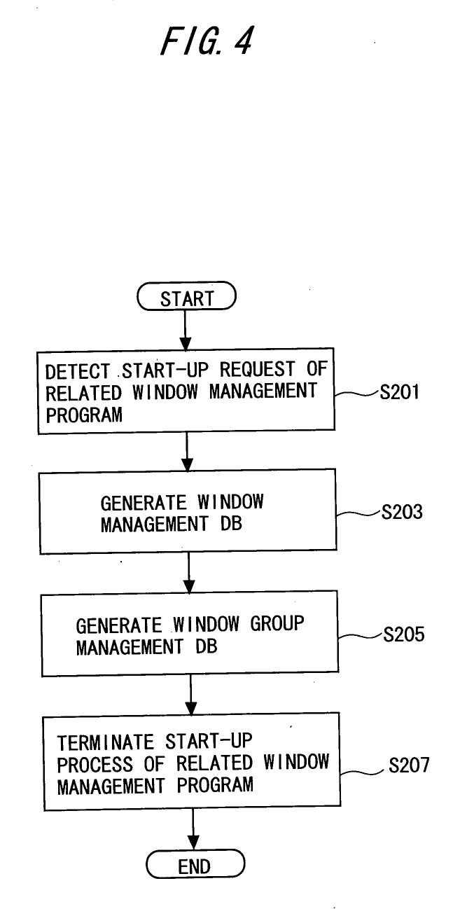

To start with, an operation when starting up the related window management program 105 will be described. FIG. 4 shows a flowchart of the operation when starting up the related window management program 105.

The control unit 102 detects a start-up request of the related window management program 105 from an operation signal corresponding to a user's operation on the operation unit 130 (S201). Upon detecting the start-up request of the related window management program 105, the control unit 102 next starts up the start-up processing program 107 in the related window program 105 stored on the memory 103, thereby generating the window management DB 119 and the window group management DB 121 (S203, S205). Thereafter, the control unit 102 terminates the execution of the start-up processing program 107, thus finishing the process for the start-up of the related window management program 105 (S207).

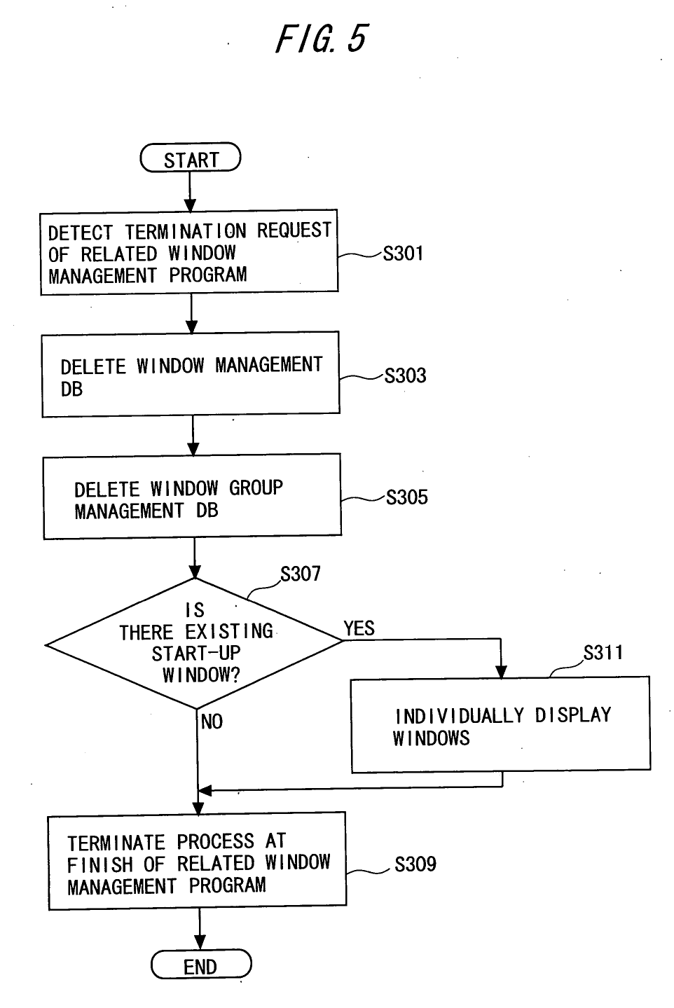

Next, an operation when terminating the related window management program 105 will be described. FIG. 5 shows a flowchart of the operation when terminating the related window management program 105. The control unit 102 detects a termination request of the related window management program 105 from an operation signal corresponding to a user's operation on the operation unit 130 (S301). Upon detecting the termination request of the related window management program 105, the control unit 102 next starts up the termination processing program 109 in the related window program 105 stored on the memory 103, thereby deleting the window management DB 119 and the window group management DB 121 built up in the memory 103(S303, S305).

Next, the control unit 102 judges whether or not there is a window (an existing start-up window) displayed on the screen of the monitor 132 as the application program is executed (S307). If there is not the existing start-up window, the control unit 102 finishes executing the termination processing program 109, thereby finishing the process for the termination of the related window management program 105 (S309). Whereas if there is the existing start-up window, the control unit 102 rules out this window from the window management object, and performs the control of individually displaying on the screen of the monitor 132 (S311). Thereafter, the control unit 102 finishes executing the terminal processing program 109, thereby finishing the process for the termination of the related window management program 105 (S309).

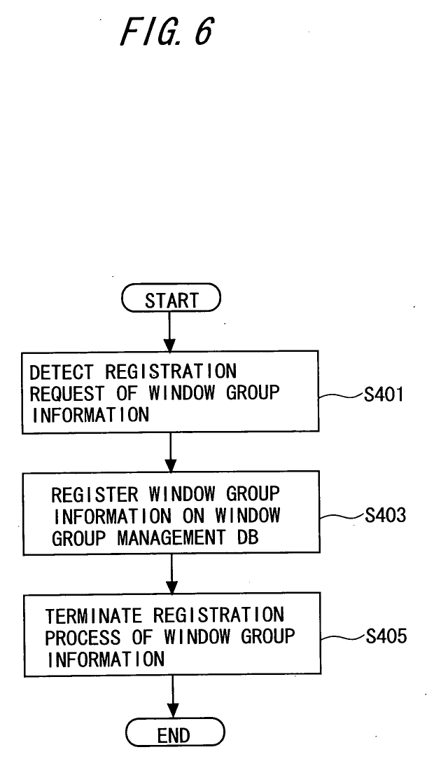

Next, an operation when registering the window group information will be explained. FIG. 6 shows a flowchart of the operation when registering the window group information.

The control unit 102 detects a request for registration of the window group information from an operation signal corresponding to a user's operation on the operation unit 130 (S401).

When detecting the request for the registration of the window group information, next, the control unit 102 starts up the window group information registering program 111 in the related window program 105 stored on the memory 103, thereby registering the window group information on the window group management DB 121 (S403). Thereafter, the control unit 102 terminates the registration process of the window group information by finishing the execution of the window group information registering program 111 (S405).

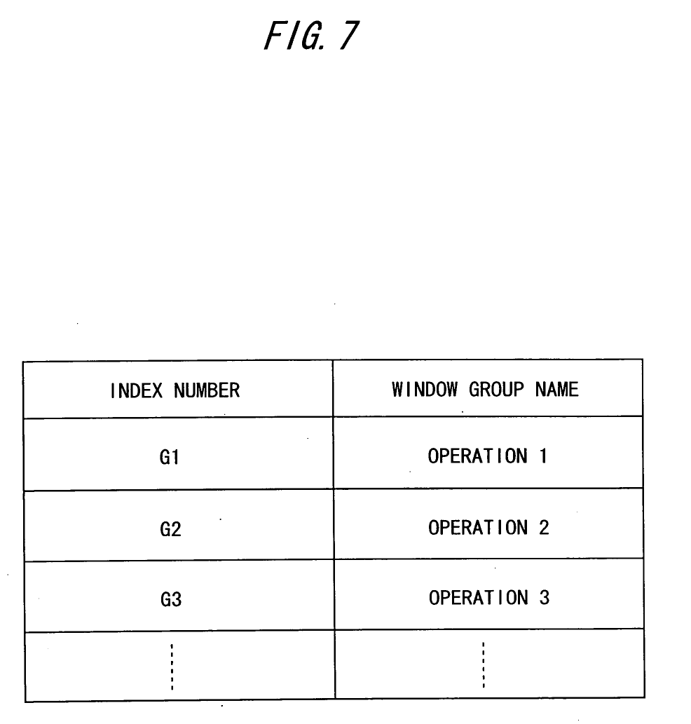

FIG. 7 shows one example of the window group information. The window group information shown in FIG. 7 consists of an index number as identifying information of the window group and a window group name.

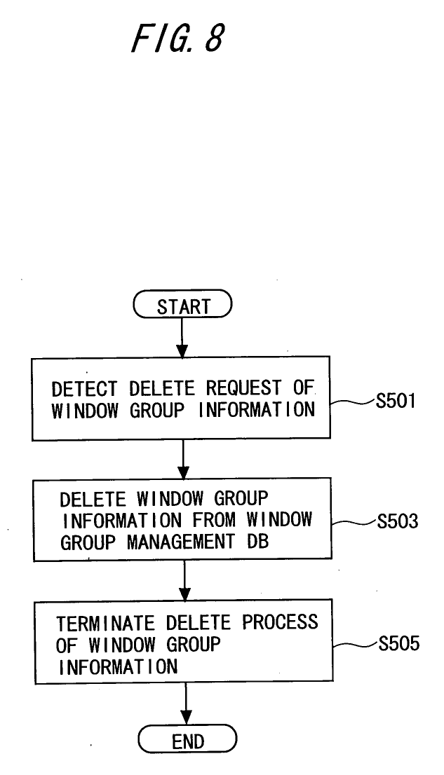

Next, an operation when deleting the window group information will be described. FIG. 8 shows a flowchart of the operation when deleting the window group information. The control unit 102 detects a request for deleting the window group information from an operation signal corresponding to a user's operation on the operation unit 130 (S501).

When detecting the request for the deletion of the window group information, next, the control unit 102 starts up the window group information delete program 113 in the related window program 105 stored on the memory 103, thereby deleting the window group information from the window group management DB 121 (S503). For example, in a state where a window group list is displayed on the screen of the monitor 132, when the user selects any one of the displayed window groups by use of the operation unit 130, the control unit 102 deletes the window group information corresponding to the thus-selected window group from the window group management DB 121. Thereafter, the control unit 102 finishes executing the window information delete program 113, thereby terminating the window group information delete process (S505).

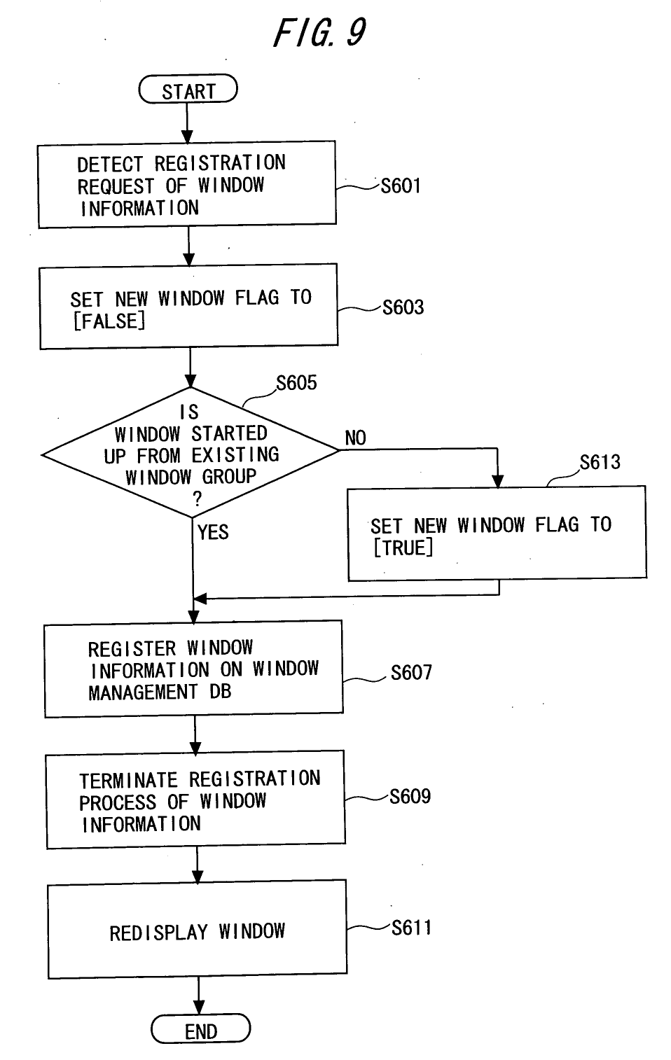

Next, an operation when registering the window information will be explained. FIG. 9 shows a flowchart of the operation when registering the window information.

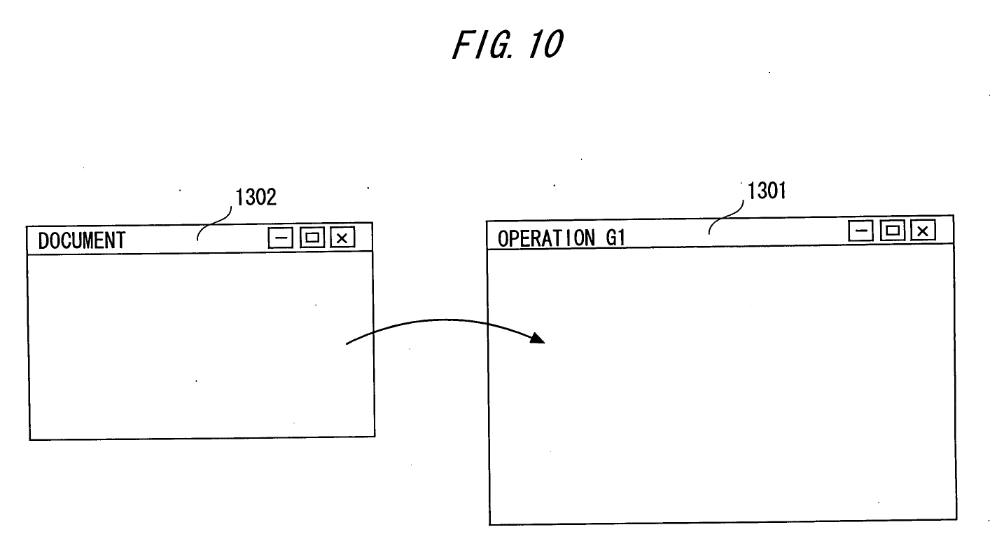

The control unit 102 detects a request for registering the window information from an operation signal corresponding to a user's operation on the operation unit 130 (S601). For instance, as shown in FIG. 10, in a state where a window (operation window) 1301 associated with the window group is displayed on the screen of the monitor 132 and a window (document window) 1302 is displayed on the screen of the monitor 132 as the application program is executed, when the user performs an operation of selecting the displayed document window 1302 and dragging the document window 1302 to the operation window 1301 by use of the operation unit 130, the control unit 102 detects the registration request of the window information associated with this document window 1302.

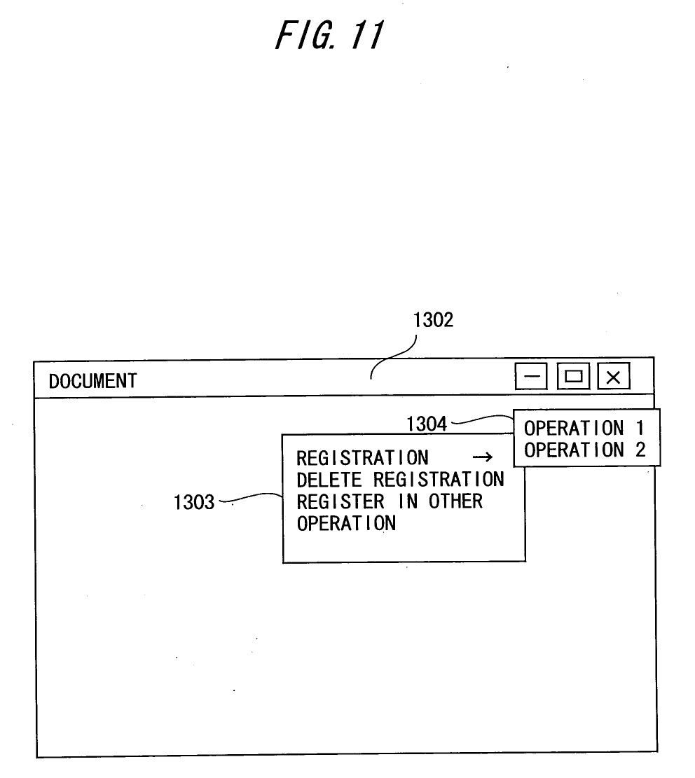

Alternatively, as shown in FIG. 11, in a state where the document window 1302 is displayed on the screen of the monitor 132, when the user performs an operation of displaying a registration menu 1303 corresponding to the displayed document window 1302 and a group menu 1304 within this registration menu 1303 and selecting any one of the window groups displayed in the group menu 1304 by use of the operation unit 130, the control unit 102 detects the registration request of the window information corresponding to the document window 1302.

Upon detecting the registration request of the window information, next, the control unit 102 starts up the window information registering program 115 in the related window program 105 stored on the memory 103, and sets, to [FALSE], a new window flag of the window corresponding to the registration target window information (S603). Herein, [FALSE] in the new window flag indicates that the window corresponding to the registration target window information is a window subordinate to the other window belonging to the existing window group like a window to be displayed afresh when any one of links is selected in other window belonging to the existing window group.

Next, the control unit 102 judges whether or not the window corresponding to the registration target window information is a window started up from within the existing window group (S605). For instance, the control unit 102, if the window corresponding to the registration target window information is the window subordinate to the other window belonging to the existing window group, judges that the window corresponding to the registration target window information is not the window started up from within the existing window group.

If the window corresponding to the registration target window information is not the window started up from within the existing window group, the control unit 102 sets, to [TRUE], the new window flag of the window corresponding to the registration target window information (S613). Herein, [TRUE] in the new window flag indicates that the window corresponding to the registration target window information is not the window subordinate to the other window belonging to the existing window group but is an independent window.

Next, the control unit 102 registers the window information on the window management DB 119 (S607). Thereafter, the control unit 102 terminates the registration process of the window information by finishing the execution of the window information registering program 115 (S609). Further, the control unit 102 controls the operation of redisplaying the window corresponding to the registered window information on the screen of the monitor 130 (S611).

On the other hand, when judging in S605 that the window corresponding to the registration target window information is the window started up from within the existing window group, the control unit 102 registers the window information on the window management DB 119 while setting, to [FALSE], the new window flag of the window corresponding to the registration target window information (S607), and terminates the registration process of the window information by finishing the execution of the window information registering program 115 (S609). Moreover, the control unit 102 effects the control of redisplaying the window associated with the registered window information on the screen of the monitor 130 (S611).

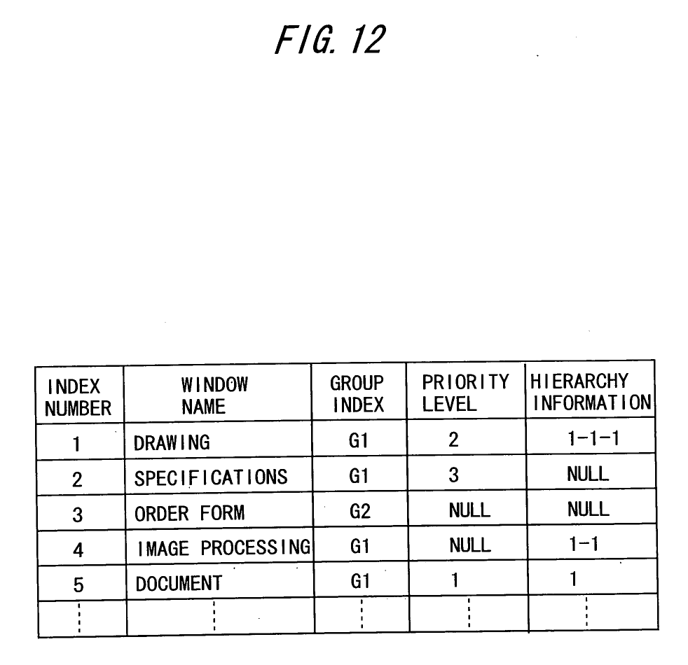

FIG. 12 shows one example of the window information. The window information shown in FIG. 12 consists of an index number as a piece of window identifying information, a window name, an index number (group index) of the window group to which the window belongs, a priority level and hierarchy information. The group index among these items represents an index number defined as the identifying information of the window group of the registration destination that is selected by the user through the operation unit 130. Further, the priority level indicates a priority level of the associated window in the window group, and the hierarchy information represents a subordinate relationship of the window.

Thus, the window information is registered on the window management DB 119, whereby the window associated with the window information is registered in the window group.

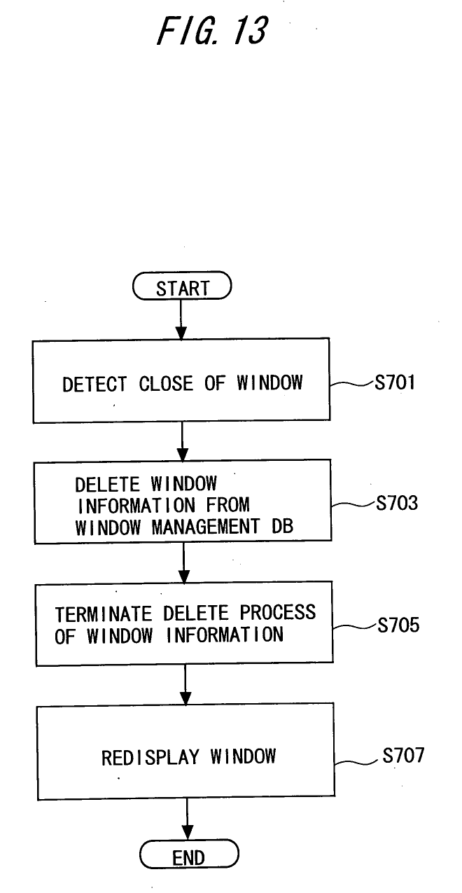

Next, an operation when deleting the window information will be described. FIG. 13 shows a flowchart of the operation when deleting the window information.

The control unit 102 detects a close of the window from an operation signal corresponding to a user's operation on the operation unit 130 (S701).

Upon detecting the close of the window, next, the control unit 102 starts up the window information delete program 117 in the related window program 105 stored on the memory 103, and deletes the window information associated with the closed window from the window management DB 119 (S703). Thereafter, the control unit 102 terminates the delete process of the window information by finishing the execution of the window information delete program 117 (S705). After this, the control unit 102 performs the control of redisplaying the window associated with the deleted window information on the screen of the monitor 130 (S707). Thus, the window information is deleted from the window management DB 119, whereby the window associated with the deleted window information does not belong to the window group and is therefore ruled out of the management target window.

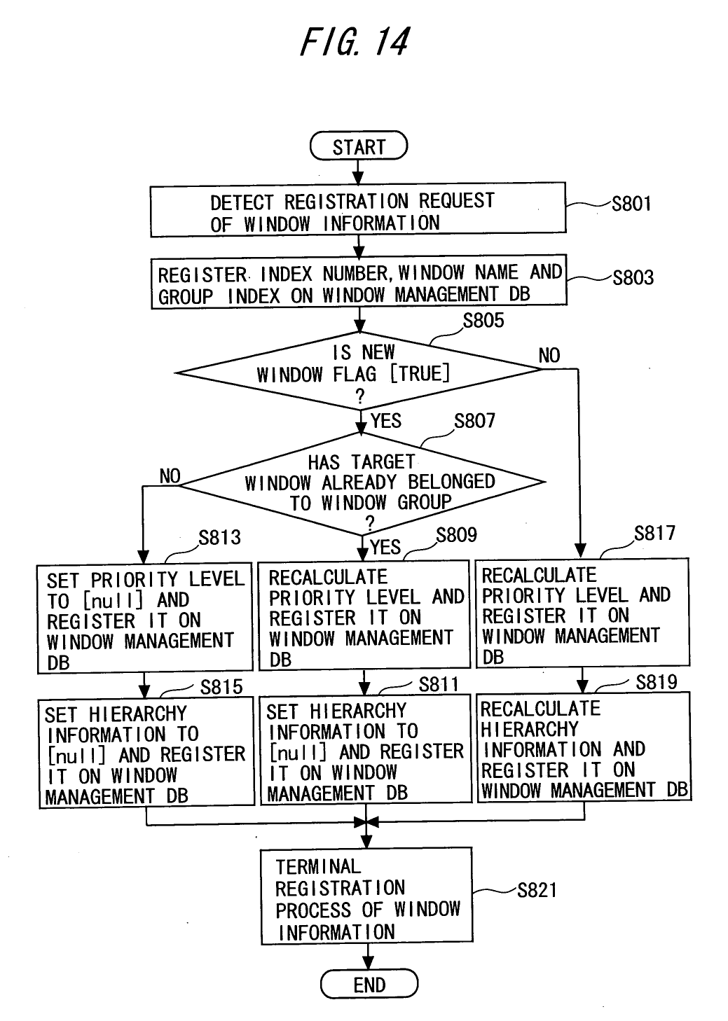

Next, other operation when registering the window information will be described. FIG. 14 shows a flowchart of the other operation when registering the window information.

The control unit 102 detects a registration request of the window information from an operation signal corresponding to a user's operation on the operation unit 130 (S801). Upon detecting the registration request of the window information, the control unit 102 next starts up the window information registering program 115 in the related window program 105 stored on the memory 103, thereby registering the window management DB 119 with the index number, the window name and the group index among pieces of window information (S803). The specific registration procedures are the same as S603 through S607 in FIG. 9.

Next, the control unit 102 judges whether or not the new window flag of the window associated with the registered window information is set to [TRUE] (S805). If the new window flag is set to [TRUE], the control unit 102 further judges whether the window (target window) associated with the registered window information has already belonged to the window group or not (S807). To be specific, the control unit 102 judges that the target window has already belonged to the window group if the window information containing the index number, the window name and the group index, which were registered in S803, has already been registered on the window management DB 119.

If the target window has already belonged to the window group, the control unit 102 recalculates the priority level in the.already-registered window information and registers this priority level on the window management DB 119 (S809). The priority levels to be recalculated are considered to be various types of priority levels such as a maximum priority level, a minimum priority level or a priority level set by the user. Moreover, the control unit 102 sets the hierarchy information in the already-registered window information to [null] representing “not-yet-set”, and thus registers the hierarchy information on the window management DB 119 (S811).

On the other hand, the control unit 102, when judging in S807 that the target window does not belong to the window group, registers the priority level in the registration target window information on the window management DB 119 in a way that sets the priority level to [null] representing “not-yet-set” (S813), and registers the hierarchy information on the window management DB 119 in a way that sets the hierarchy information to [null] representing “not-yet-set” (S815).

Further, the control unit 102, when judging in S805 that the new window flag is not set to [TRUE], recalculates the priority level in the registration target window information and registers this priority level on the window management DB 119 (S817). Moreover, the control unit 102 recalculates the hierarchy information in the registration target window information and registers on the window management DB 119 (S819).

After the processes in S811, S815 and S819, the control unit 102 terminates the registration process of the window information by finishing the execution of the window information registering program 115 (S821).

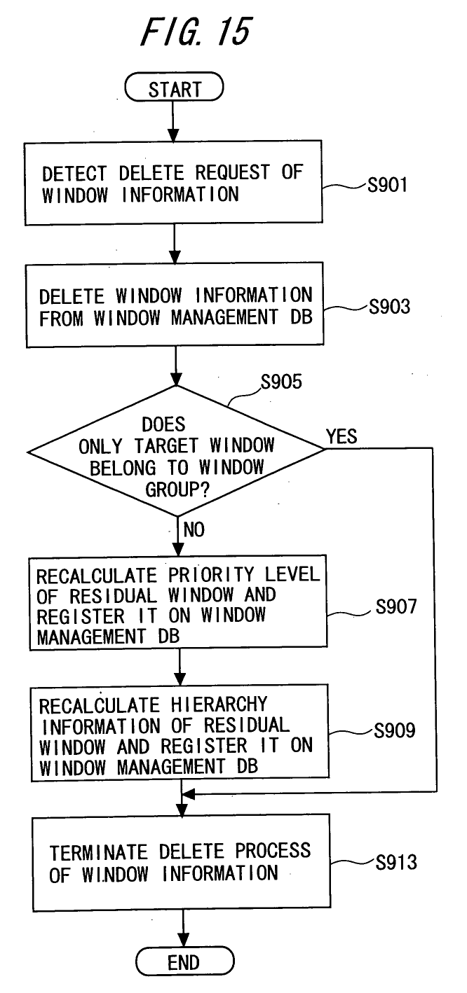

Next, other operation when deleting the window information will be explained. FIG. 15 shows a flowchart of the other operation when deleting the window information.

The control unit 102 detects a delete request of the window information from an operation signal corresponding to a user's operation on the operation unit 130 (S901). When detecting the delete request of the window information, next, the control unit 102 starts up the window information delete program 117 in the related window program 105 stored on the memory 103, and deletes the window information associated with the delete request from the window management DB 119 (S903).

Next, the control unit 102 judges whether or not only the window associated with the deleted window information belongs to the window group to which the window associated with the deleted window information has belonged (S905). Specifically, the control unit 102, if the window information having the group index contained in the deleted window information does not exist in the window management DB 119, judges that only the window associated with the deleted window information belongs to the window group to which the window associated with the deleted window information has belonged.

When only the window associated with the deleted window information belongs to the window group to which the window associated with the deleted window information has belonged, the control unit 102 terminates the delete process of the window information by finishing the execution of the window information delete program 117 (S913).

On the other hand, if other window belongs to the window group to which the window associated with the deleted window information has belonged, the priority level and the hierarchy information in the window information associated with the residual window need recalculating in accordance with the deletion of the window information. Therefore, the control unit 102 recalculates the priority level in the window information associated with the residual window, and registers this priority level on the window management DB 119 (S907). Further, the control unit 102 recalculates the hierarchy information in the registration target window information and registers this hierarchy information on the window management DB 119 (S909). Thereafter, the control unit 102 terminates the delete process of the window information by finishing the execution of the window information delete program 117 (S913).

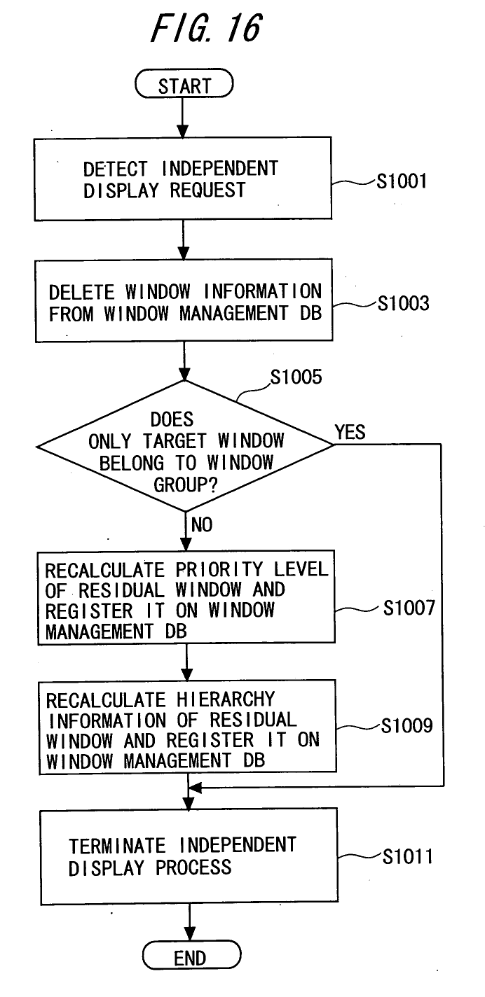

Next, another example of the operation when independently displaying the window will be described. FIG. 16 shows a flowchart of the operation when independently displaying the window. Note that the independent display of the window connotes that the window is displayed by releasing the window from belonging to the window group.

The control unit 102 detects an independent display request of the window from an operation signal corresponding to a user's operation on the operation unit 130 (S1001). When detecting the independent display request of the window, the control unit 102 next starts up the window information delete program 117 in the related window management program 105 stored on the memory 103, and deletes the window information about the window associated with the independent display request from the window management DB 119 (S1003).

Next, the control unit 102 judges whether or not only the window associated with the deleted window information belongs to the window group to which the window associated with the deleted window information has belonged (S1005). If only the window associated with the deleted window information belongs to the window group to which the window associated with the deleted window information has belonged, the control unit 102 terminates the delete process of the window information by finishing the execution of the window information delete program 117 (S1011).

On the other hand, if other window belongs to the window group to which the window associated with the deleted window information has belonged, the priority level and the hierarchy information in the window information associated with the residual window need recalculating in accordance with the deletion of the window information. Therefore, the control unit 102 recalculates the priority level in the window information associated with the residual window, and registers this priority level on the window management DB 119 (S1007). Further, the control unit 102 recalculates the hierarchy information in the registration target window information and registers this hierarchy information on the window management DB 119 (S1009). Thereafter, the control unit 102 terminates the delete process of the window information by finishing the execution of the window information delete program 117 (S1011).

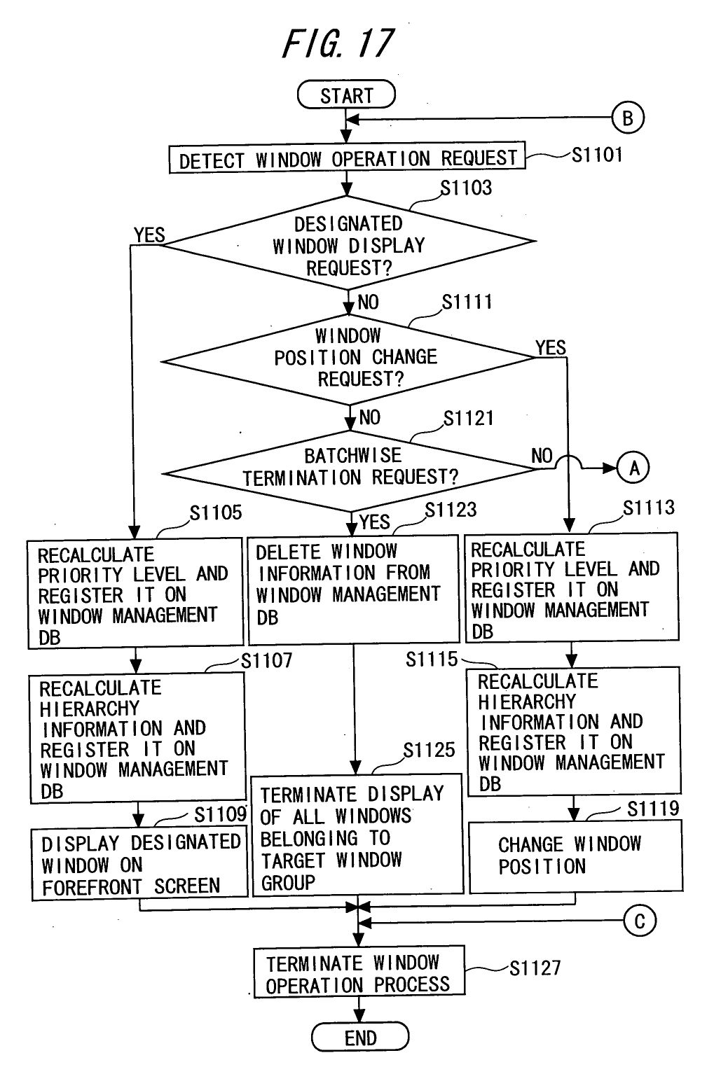

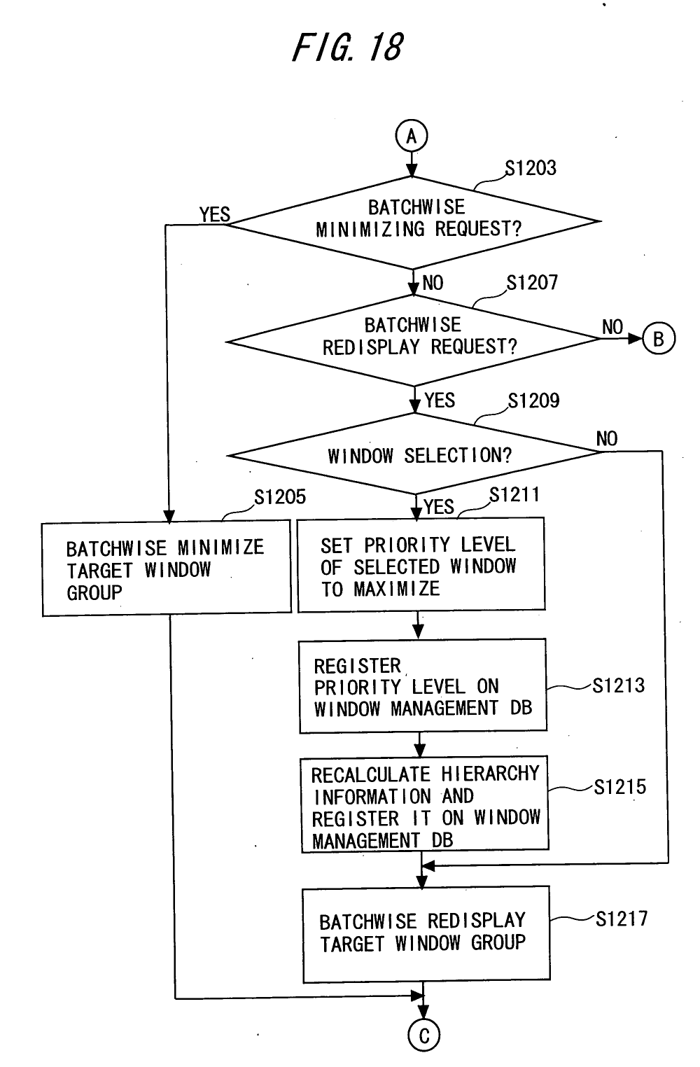

Next, an operation when operating the window will be explained. FIGS. 17 and 18 show flowcharts of the operation when operating the window. These processes are actualized in such a way that the control unit 102 executes the window operation program 131 and the batch minimizing/redisplay program 133 in the related window program 105 stored on the memory 103.

The control unit 102 detects an operation request of the window from an operation signal corresponding to a user's operation on the operation unit 130 (S1101). Herein, the operation request of the window connotes, for instance, a request corresponding to such an operation that the user selects a window title display area and a task bar display area that exist in an upper part of the window by use of the operation unit 130.

Upon detecting the operation request of the window, next, the control unit 102 judges whether or not the operation request of the window is a display request of the window (designated window) designated by the user (S1103).

When the operation request of the window is the display request of the designated window, the control unit 102 recalculates the priority level in the window information associated with the designated window, and registers this priority level on the window management DB 119 (S1105). Herein, the control unit 102, for example, maximizes the priority level of the designated window. Further, the control unit 102 recalculates the hierarchy information in the window information associated with the designated window, and registers this piece of hierarchy information on the window management DB 119 (S1107). Subsequently, the control unit 102 performs the control of displaying the designated window on the forefront screen on the screen of the monitor 132 (S1109).

Whereas if the operation request of the window is not the display request of the designated window (when a negative judgment is made in S1103), the control unit 102 judges whether or not the operation request of the window is a window position change request (S1111). Herein, the change of the window position implies a change of a window display order in the window group.

When the operation request of the window is the window position change request, the control unit 102 recalculates the priority level in the window information associated with a positional change target window, and registers this priority level on the window management DB 119 (S1113). Herein, the control unit 102 calculates the priority level corresponding to the window position after being changed. Moreover, the control unit 102 recalculates the hierarchy information in the window information associated with the positional change target window, and registers the hierarchy information on the window management DB 119 (S1115). Next, the control unit 102 effects the control of changing the window position on the screen of the monitor 132 (S1119).

Further, when the operation request of the window is not the window position change request (a negative judgment is made in S1111), the control unit 102 judges whether the operation request of the window is a batch termination request or not (S1121). Herein, the batch termination connotes the display termination of all the windows within the window group. If the operation request of the window is the batch termination request, the control unit 102 deletes pieces of window information associated with the windows belonging to the batch termination target window group from the window management DB 119 (S1123). To be specific, the control unit 102 deletes all the window information containing, as the group index, the index number defined as the identifying information of the batch termination target window group. Next, the control unit 102 executes the control of batch terminating the display of all the windows belong to the batch termination target window group on the screen of the monitor 132 (S1125).

Further, when judging in S1121 that the operation request of the window is not the batch termination request, the control unit 102 advances the control to S1203 in FIG. 18 (see FIGS. 17 and 18(A)). Then, the control unit 102 judges whether the operation request of the window is a batch minimizing request or not (S1203). Herein, the batch minimizing request indicates that the display of all the windows within the window group is batch-minimized.

If the operation request of the window is the batch-minimizing request, the control unit 102 performs the control of batch-minimizing the display of the target window group on the screen of the monitor 132 (S1205).

Whereas if the operation request of the window is not the batch-minimizing request (a negative judgment is made in S1203), the control unit 102 judges whether or not the operation request of the window is a batch redisplay request (S1207). Herein, the batch redisplay implies that all the windows in the window group are batch-redisplayed.

Then, if the operation request of the window is not the batch redisplay request, the control unit 102 returns the control to S1101 in FIG. 17 (see FIGS.17 and 18(B)).

Whereas if the operation request of the window is the batch redisplay request, the control unit 102 judges whether or not any one of the windows within the batch redisplay target window group is selected in the operation request of the window (S1209).

When the window is selected, the control unit 102 maximizes the priority level in the window information associated with the selected window (S1211), and registers this priority level on the window management DB 119 (S1213). Furthermore, the control unit 102 recalculates the hierarchy information in the window information associated with the selected window and registers the hierarchy information on the window management DB 119 (S1215). Next, the control unit 102 performs the control of batch-redisplaying the target window group on the screen of the monitor 132 (S1217).

If the window is not selected in S1209, the batch redisplaying of the target window group is executed in accordance with the priority level and the hierarchy information that are registered on the window management DB 119 at the present (S1217). Thereafter, the control unit 102 advances control to S1127 in FIG. 17 (see FIGS.17 and 18(C)).

After the processes in S1109, S1119, S1125, S1205 or S1217, the control unit 102 terminates the operation process of the window by finishing the execution of the window program 131 and the batch minimizing/redisplay program 133 (S1127).

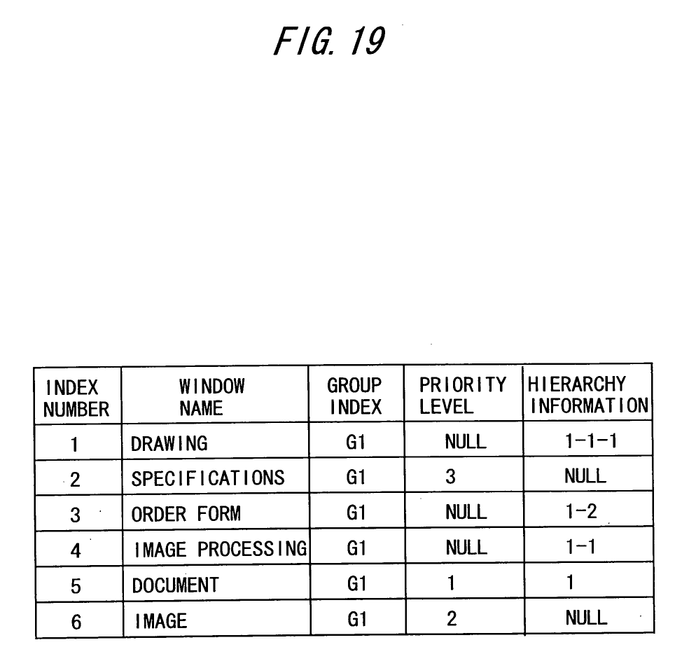

Next, a specific example of the screen display will be described. It should be noted that the following discussion will be made on the assumption that the window information in the window management DB 119 is what is shown in FIG. 19. As shown in FIG. 19, each of the windows associated with the index numbers 1 through 6 belongs to the window group (window group G1) of which a group index is [G1]. Further, the priority levels are assigned such that a maximum [3] is assigned to [specifications] of the window given an index number “2”, and the priority levels are hereinafter sequentially given, wherein [2] is assigned to an [image] of the window given an index number “6”, and [1] is assigned to a [document] of the window given an index number “5”. Further, [image processing] of the window given an index number “4” and an [order form] of the window given an index number “3” are subordinate to the [document] of the window given the index number “5”, and moreover a [drawing] of the window given an index number “1” is subordinate to the [image processing] of the window given the index number “4”. Therefore, pieces of hierarchy information representing the subordinate relationship are given such that [1] is given to the [document] of the window having the index number “5”, [1-1] is given to the [image processing] of the window having the index number “4”, [1-2] is given to the [order form] of the window having the index number “3”, and [1-1-1] is given to the [image processing] of the window having the index number “4”.

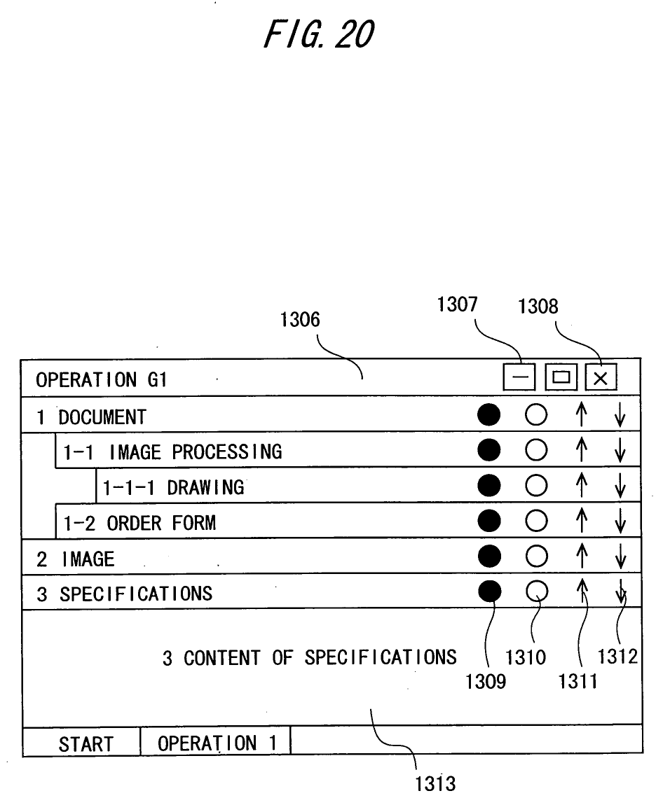

When the window information is set as shown in FIG. 19, the windows exhibiting higher priority levels are displayed on more front sides in an operation window 1306 associated with the window group G1 as displayed on the screen in FIG. 20, wherein a content 1313 of the [specifications] of the window having a maximum priority level is displayed on the forefront screen. Further, the windows subordinate to other window are displayed under the host window with slight rightward deviations enabling the subordinate relationship to be visually recognized.

Moreover, buttons 1307 and 1308 are displayed on an upper right part in the operation window 1306. When the button 1307 is selected by the user's operation on the operation unit 130, the control unit 102 performs the control of minimizing the display of the operation window 1306 (S1205 in FIG. 18). Further, when the button 1308 is selected by the user's operation on the operation unit 130, the control unit 102 effects the control of batch-terminating the display of all the windows belonging to the operation window 1306 (S1125 in FIG. 17).

Still further, in FIG. 20, buttons 1309, 1310, 1311 and 1312 are displayed in each window. When any one of the buttons 1309 is selected by the user's operation on the operation unit 130, the control unit 102 similarly executes the control of batch-terminating the display of all the windows belonging to the operation window 1306 (S1125 in FIG. 17). Further, when any one of the buttons 1310 is selected by the user's operation on the operation unit 130, the control unit 102 performs the control of displaying the window associated with the selected button 1310 on the forefront screen (S1109 in FIG. 17). Moreover, when any one of the buttons 1311 and 1312 is selected by the user's operation on the operation unit 130, the control unit 102 effects the control of moving upward or downward a position of the window associated with the selected button 1311 or 1312 (S1119 in FIG. 17).

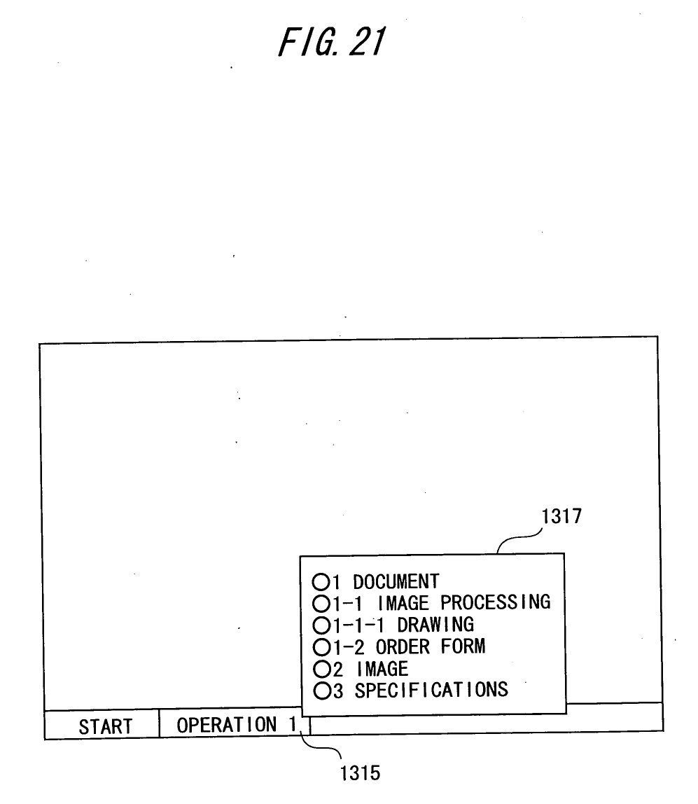

Moreover, when the window information is set as shown in FIG. 19, a task bar 1315 associated with the window group G1 is displayed as displayed on the screen in FIG. 21. When the task bar 1315 is selected by the user's operation on the operation unit 130, the control unit 102 performs the control of batch-redisplaying the window group G1 (S1217 in FIG. 18). Moreover, as displayed on the screen in FIG. 21, a window menu 1317 is displayed by the user's operation on the operation unit 130, and, when any one of the windows is selected in this window menu 1317, the control unit 102 sets the priority level in the window information associated with this selected window to maximization, and conducts the control of batch-redisplaying the window group G1 (S1211 and S1217 in FIG. 18).

Thus, on the user terminal 102 in the embodiment, the control unit 102 registers each window in any one of the window groups corresponding to the operations of the user, and further executes the predetermined process related to the display of the window by the window-group basis. The user is therefore able to quickly recognize which operation each of the windows corresponds to.

Further, the priority levels are set in the respective windows within the window group, and hence it is possible to control the proper displaying of the window corresponding to the priority level.

Moreover, if the windows have the subordinate relationship, the window display is carried out based on this subordinate relationship, and it is therefore feasible to perform the proper display control of the window according to the hierarchy by clarifying the subordinate relationship between the windows.

Still further, the unnecessary window can be excluded from the management target windows by deleting the window information thereof.

It is to be noted that the above embodiment has exemplified the priority level that becomes higher as its numeric value is large. The embodiment of the present invention is not, however, limited to this procedure. Namely, there may be taken such a process that the priority level becomes lower as the numeric value of the priority level is large, wherein when the priority level is 1, the priority level is highest.

<<Storage Medium Readable by Computer>>

A program, etc. for making the computer, other device, machine, etc. actualize any one of the functions can be stored on a storage medium readable by the computer, etc.. Then, the computer, etc. reads and executes the program on this storage medium, whereby the function can be provided.

Herein, the storage medium readable by the computer, etc. connotes a storage medium capable of storing information such as data, programs, etc. electrically, magnetically, optically, mechanically or by chemical action, which can be read from the computer and so on. Among these storage mediums, for example, a flexible disc, a magneto-optic disc, a CD-ROM, a CD-R/W, a DVD, a DAT, an 8 mm tape, a memory card, etc. are given as those demountable from the computer.

Further, a hard disc, a ROM (Read-Only Memory), etc. are given as the storage mediums fixed within the computer.

<<Industrial Applicability>>

As discussed above, the window management system according to the present invention has such an effect that the user can quickly recognize which operation each window corresponds to, and is useful as the window management system.

1. A window management system managing a window displayed on a screen, upon executing an application program, comprising:
a first registration unit registering information of a plurality of window groups corresponding to operation of a user;
a second registration unit registering information of the window as being related to any one of the plurality of window groups; and
a display control unit executing a predetermined process related to the display of the window by a window-group basis on the basis of the information of the plurality of window groups registered in the first registration unit and the information of the window registered in the second registration unit.

2. The window management system according to claim 1, further comprising
a first setting unit setting priority of the window,
wherein the display control unit controls to display the window on the basis of the priority level of the window.

3. The window management system according to claim 1, further comprising
a second setting unit setting a window hierarchy with respect to a first window displayed on the screen upon executing a predetermined application program and a second window displayed on the screen upon executing an application program to be executed in subordination to the predetermined application program,
wherein the display control unit controls to display the window on the basis of the window hierarchy.

4. The window management system according to claim 1, wherein the display control unit performs any one of controls of displaying the operation window containing the windows of which information is registered as being related to one of the plurality of window groups by the second registration unit, displaying any one of the windows contained in the operation window on a forefront screen, batch-terminating the display of the windows contained in the operation window, minimizing the display of the operation window, maximizing the minimized display of the operation window, and changing a position of the window within the operation window.

5. The window management system according to claim 1, further comprising a delete unit deleting the information of the window.

6. A window management method managing a window displayed on a screen, upon executing an application program, comprising:
a first registration step of registering information of plurality of window groups corresponding to operation of a ser;
a second registration step of registering information of the window as being related to any one of the plurality of window groups; and
a display control step of executing a predetermined process related to the display of the window by a window-group basis on the basis of the information of the plurality of window groups registered by the first registration step and the information of the window registered by the second registration step.

7. The window management method according to claim 6, further comprising a first setting step of setting priority of the window,
wherein the display control step controls to display the window on the basis of the priority level of the window.

8. The window management method according to claim 6, further comprising
a second setting step of setting a window hierarchy with respect to a first window displayed on the screen upon executing a predetermined application program and a second window displayed on the screen upon executing an application program to be executed in subordination to the predetermined application program,
wherein the display control step controls to display the window on the basis of the window hierarchy.

9. The window management method according to claim 6, wherein the display control step performs any one of controls of displaying the operation window containing the windows of which information is registered as being related to one of the plurality of window groups by the second registration step, displaying any one of the windows contained in the operation window on a forefront screen, batch-terminating the display of the windows contained in the operation window, minimizing the display of the operation window, maximizing the minimized display of the operation window, and changing a position of the window within the operation window.

10. The window management method according to claim 6, further comprising a delete step of deleting the information of the window.

11. A window management program executed in a window management system for managing a window displayed on a screen, upon executing an application program, comprising:
a first registration step of registering information of a plurality of window groups corresponding to operation of a user;
a second registration step of registering information of the window as being related-to any one of the plurality of window groups; and
a display control step of executing a predetermined process related to the display of the window by a window-group basis on the basis of the information of the plurality of window groups registered in the first registration step and the information of the window registered in the second registration step.

12. The window management program according to claim 11, further comprising a first setting step of setting priority of the window,
wherein the display control step controls to display the window on the basis of the priority level of the window.

13. The window management program according to claim 11, further comprising
a second setting step of setting a window hierarchy with respect to a first window displayed on the screen upon executing a predetermined application program and a second window displayed on the screen upon executing an application program to be executed in subordination to the predetermined application program,
wherein the display control step controls to display the window on the basis of the window hierarchy.

14. The window management program according to claim 11, wherein the display control step performs any one of controls of displaying the operation window containing the windows of which information is registered as being related to one of the plurality of window groups by the second registration step, displaying any one of the windows contained in the operation window on a forefront screen, batch-terminating the display of the windows contained in the operation window, minimizing the display of the operation window, maximizing the minimized display of the operation window, and changing a position of the window within the operation window.

15. The window management program according to claim 11, further comprising a delete step of deleting the information of the window.
